(19) United States
(12) Patent Application Publication
(10) Pub. No.: US 2004/0213155 A1
(43) Pub. Date: Oct. 28, 2004

(54) Multi-processor data traffic shaping and forwarding

(75) Inventors: Li Xu, Tustin, CA (US); Steven Hsieh, Placentia, CA (US); Eric Lin, Hacienda Heights, CA (US)

Correspondence Address: TUCKER, ELLIS & WEST LLP, 1150 HUNTINGTON BUILDING, 925 EUCLID AVENUE, CLEVELAND, OH, 44115-1475, US

(73) Assignee: Mitel Semiconductor V.N. Inc.

(21) Appl. No.: 09/821,664

(22) Filed: Mar. 29, 2001

(51) Int. Cl. H04L 12/26; H04L 12/28

(52) U.S. Cl. 370/232; 370/235; 709/223

(57) ABSTRACT

A data switching engine is provided. The data switching engine includes a switching processor used for data traffic forwarding and an traffic management processor used for data traffic management. The switching processor retains all functionality of currently deployed data switching equipment as it relates to data switching and forwarding. The traffic management processor performs data traffic characterization, statistics extraction, service level agreement enforcement, etc. The use of the traffic management processor reduces computational loads otherwise imposed on the switching processor while maintaining or surpassing levels of service provided by currently deployed data switching equipment.

### FIELD OF THE INVENTION

The invention relates to data traffic switching, and in particular to methods and apparatus for shaping and forwarding data traffic flows in a data transport network.

### BACKGROUND OF THE INVENTION

Currently deployed data switching equipment makes use of a switching engine responsible for data traffic management and forwarding. Data traffic forwarding is done based on a group of parameters including, but not limited to: source and destination Media Access Control Addressees (MAC ADDRs), Virtual Local Area Network IDentifier (VLAN ID), etc.

Different types of data traffic flows can be supported including but not limited to: data traffic subject to Service Level Agreements (SLA) and best effort data traffic. SLA data traffic typically has flow parameters including but not limited to: a peak data transfer rate, sustainable data transfer rate, maximum burst size, minimum data transfer rate, etc. whereas best effort data traffic is typically bursty being conveyed as it is generated.

Situations arise in which an output port of a data switching node becomes oversubscribed. The output port is said to be oversubscribed when bandwidth is allocated to multiple data sessions forwarding data over the output port based on sustainable data transfer rates to take advantage of statistical multiplexing but, temporarily due to variations in data traffic throughput of each data session, the aggregated data flow requires more bandwidth than can be conveyed physically on the corresponding physical interface. In such instances, the switching engine will perform flow control as per Annex 31A of the IEEE 802.3x 1998 Edition standard specification, pp. 1205-1215, which is incorporated herein by reference, to regulate data traffic flows.

Driving trends in the field of data switching, call for higher port density per data switching node, higher data transfer rates per link, higher data density per physical medium, denser channelization per port, etc. to support bandwidth intensive services. Sophisticated data flow control is needed to ensure that any single data traffic session does not overuse the assigned bandwidth or (gets locked out by other data sessions.

Data flow control requires gathering and processing of data traffic statistics. The granularity of the gathered data traffic statistical information depends on the type of services provided, Quality-of-Services (QoS) to be guaranteed, interface types, channelization level, etc. Data traffic statistics need to be gathered at the data switching node.

Therefore, in order to implement data flow control, intensive real time computation is necessary. These computations include but are not limited to data rate calculations, data throughput threshold comparisons, flow throughput enforcement, etc.

Currently deployed data switching equipment makes use of a switching engine having a main processor performing data traffic forwarding as well as data traffic management. While these techniques are notable, as higher data traffic throughput is required to be processed by data switching equipment, the computational load required for data traffic management places high demands on the main switching engine processor. General practice in the art teaches the use of higher computational power processors to relieve processing demands of the data switching device.

There therefore is a need to provide methods and apparatus reducing computational loads on main switching engine processors while maintaining or surpassing previously provided levels of service.

### SUMMARY OF THE INVENTION

In accordance with an embodiment of the invention, a switching engine having a data switching processor and a traffic management processor is provided. The switching processor retains data traffic forwarding functionally while the traffic management processor performs data traffic management.

By using dedicated traffic management processors to perform data traffic management, the switching processor of the switch engine is dedicated to switching data traffic. The traffic management processor performs data traffic management including updating current data traffic statistics and enforcing SLA guarantees.

### BRIEF DESCRIPTION OF THE DIAGRAMS

The features, and advantages of the invention will become more apparent from the following detailed description of the preferred embodiments with reference to the attached diagrams wherein:

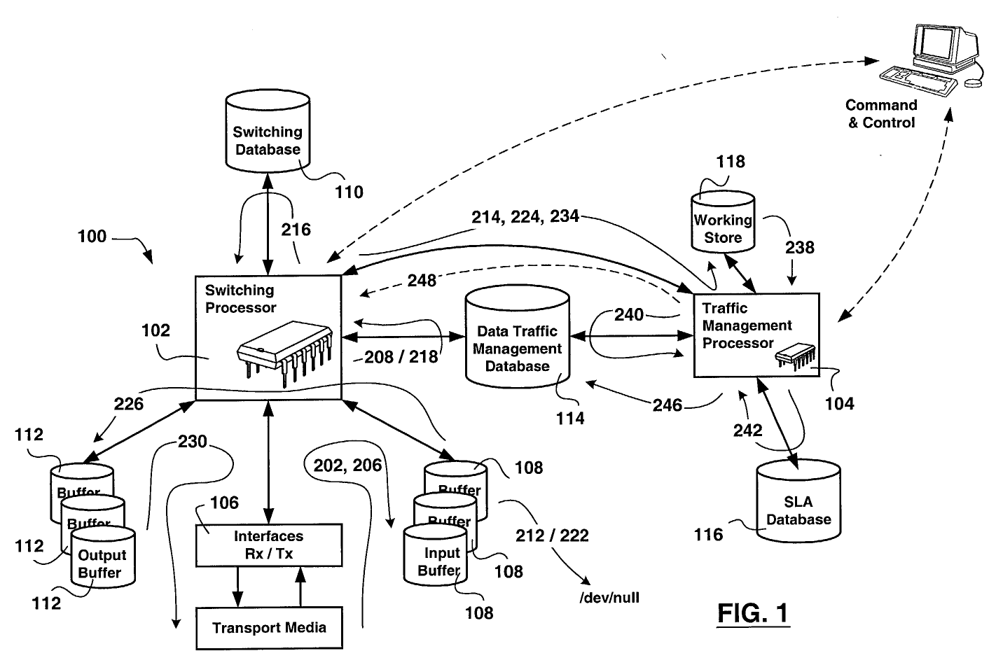

FIG. 1 is a schematic diagram showing elements of a switching engine in accordance with a preferred embodiment of the invention;

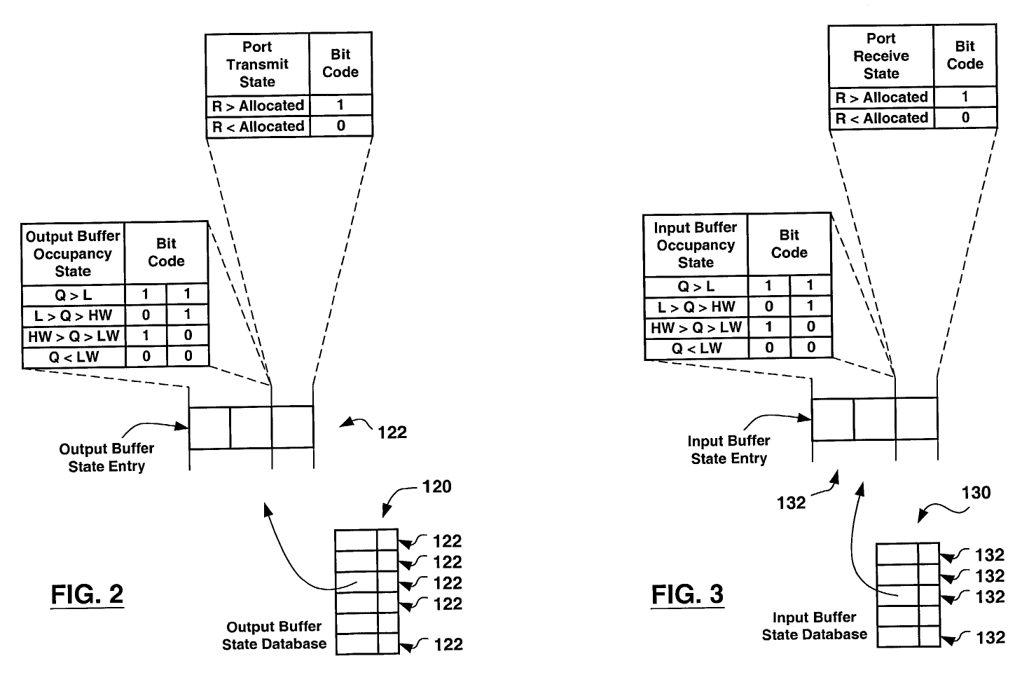

FIG. 2 is a schematic diagram showing an output buffer state database portion of the data traffic management database in accordance with an exemplary embodiment of the invention;

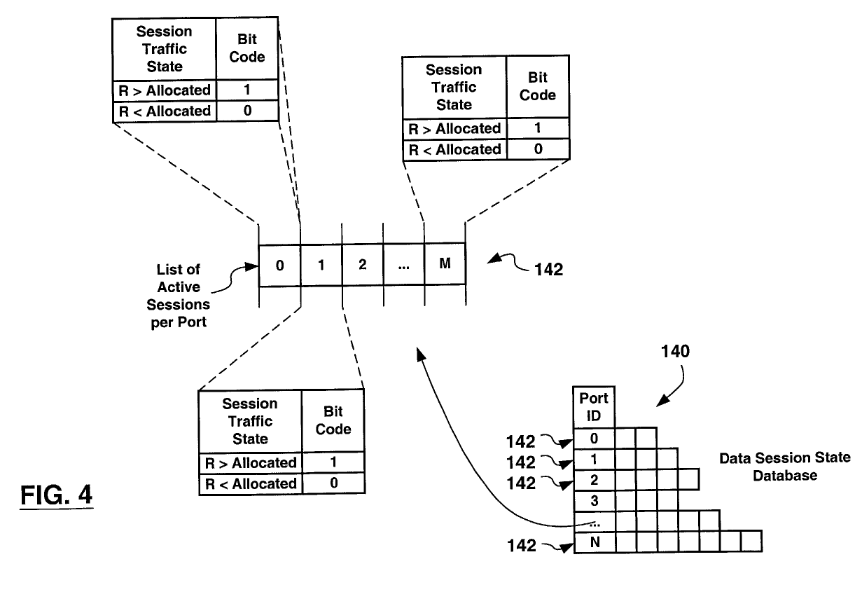

FIG. 3 is a schematic diagram showing an input buffer state database portion of the data traffic management database in accordance with an exemplary embodiment of the invention;

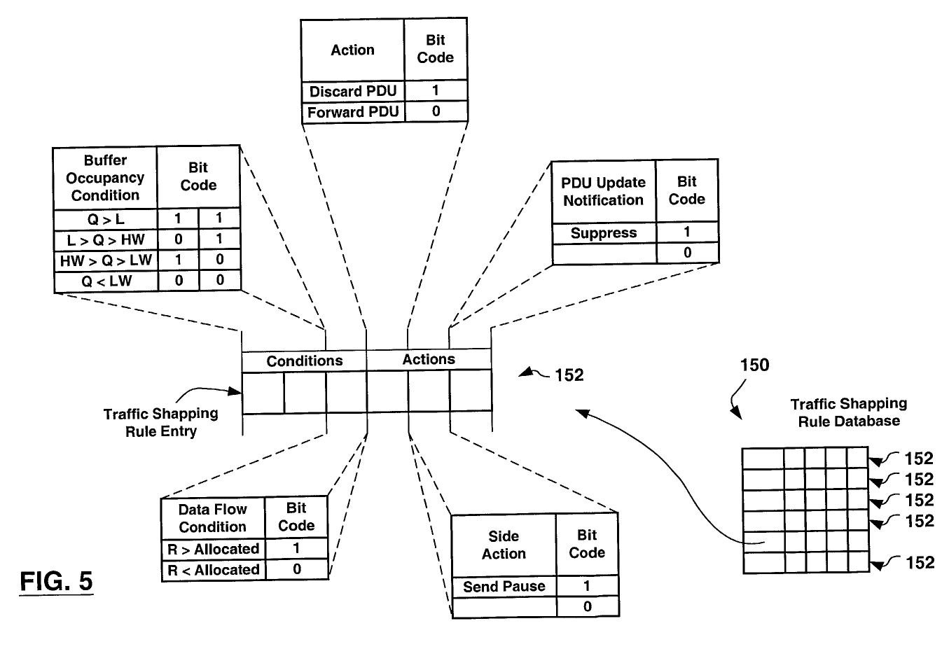

FIG. 4 is a schematic diagram showing a data session state database portion of the data traffic management database in accordance with an exemplary embodiment of the invention;

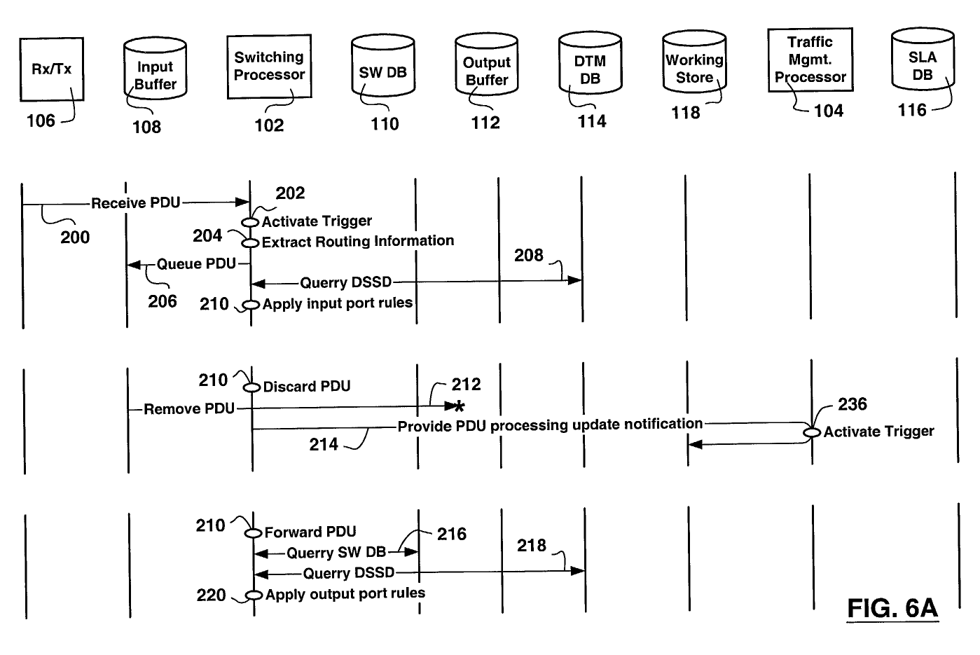

FIG. 5 is a schematic diagram showing a data traffic shaping rule database portion of the data traffic management database in accordance with an exemplary embodiment of the invention; and

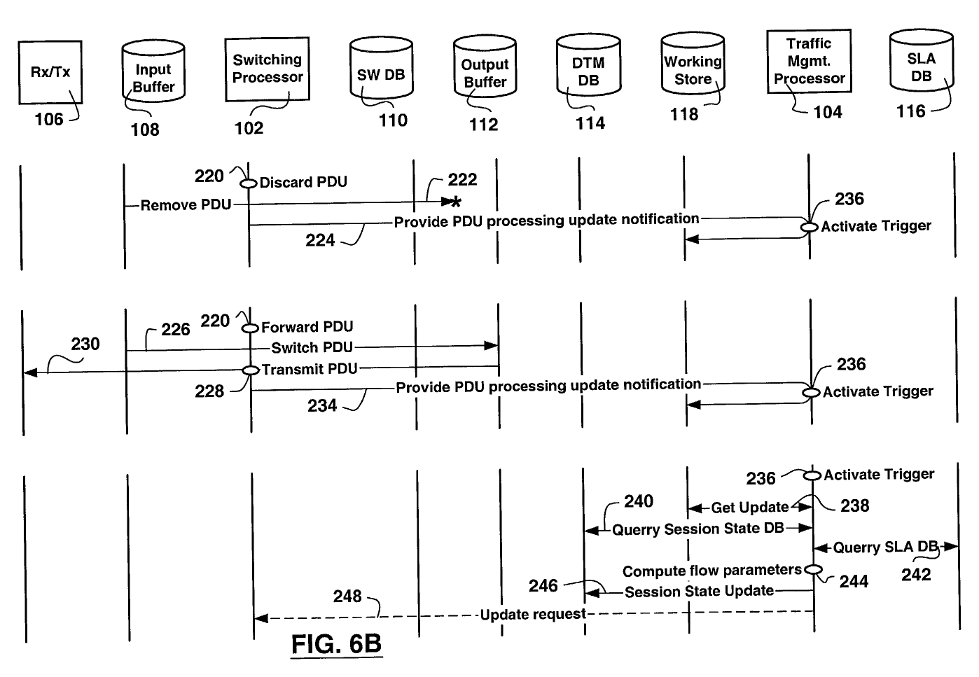

FIG. 6 is a flow diagram showing process steps performing data traffic forwarding and management in accordance with an exemplary embodiment of the invention.

It will be noted that like features bear similar labels.

### DETAILED DESCRIPTION OF THE EMBODIMENTS

In accordance with a preferred embodiment, FIG. 1 is a schematic diagram showing elements of a switching engine in accordance with a preferred embodiment of the invention.

The switching engine, generally shown at 100, preferably includes a switching processor 102 and a traffic management processor 104.

The switching processor 102 retains standard data switching functionality including: receiving (202) Payload Data Units (PDUs) from physical interfaces 106, buffering (206) PDUs into input buffers 108, querying (216) a SWitching DataBase (SW DB) 110 to perform data switching, enforcing data traffic flow constraints in discarding (212, 222) or forwarding PDUs, switching data traffic by moving (226) PDUs from input buffers 106 to output buffers 112 prior to transmission (230), and scheduling PDUs for transmission over the physical interfaces 106.

Each PDU may represent: data packet, a cell, a frame, etc.

In accordance with the preferred embodiment of the invention, enforcement of data traffic flow constraints is performed by the switching processor 102 subject to data traffic management information held in a Data Traffic Management DataBase (DTM DB) 114 maintained by the traffic management processor 104. The data traffic processor 104 has at its disposal a Service Level Agreement DataBase (SLA DB) 116 storing session specific data flow parameters.

In accordance with an exemplary embodiment of the invention traffic management information is stored in tabular form. Other methods of traffic management information storage are known and the invention is not limited as such. In switching PDUs, the switching processor 102 can refer to one or more such look-up tables of the DTM DB 114 to make decisions about actions to be taken.

The DTM DB 114 may include, but is not limited to: resource state information—examples of which are shown below with reference to FIG. 2, FIG. 3, and FIG. 4—and storage of data traffic shaping heuristics—an example of which is shown below with reference to FIG. 6.

The number of resources to be tracked depends on the complexity of data flow control to be effected. The number of states pertaining to each tracked resource depends on the granularity of the control to be effected. The complexity of the data traffic management database also may be bound by the processing power of the switching processor 102 and the traffic management processor 104.

In accordance with a preferred embodiment of the invention, each look-up table in the DTM DB 114 is kept at a minimum size. Preferably the look-up tables hold bitmap coded states for easy processing by switching processor 102. Other implementations my be used without limiting the invention thereto.

In accordance with an exemplary embodiment of the invention, the DTM DB 114 can track the utilization of output buffers (FIG. 2), input buffers (FIG. 3), port utilization states (FIG. 2, FIG. 3), output port unicast rate distributions, etc. Depending on the implementation it may be necessary to keep track of the data traffic statistics for each data session (FIG. 4).

FIG. 2 is a schematic diagram showing an output buffer state database portion of the data traffic management database in accordance with an exemplary embodiment of the invention.

The output buffer state database may be implemented via look-up table 120 having output buffer state entries 122. An exemplary output buffer state entry 122 is shown to store a current bit encoded state of the associated output buffer 112.

In accordance with the example shown, two bits may be used to encode a current output buffer occupancy state from a selection of states corresponding to conditions such as:

“buffer is lightly used”: a number Q of PDUs pending processing is lower than a low watermark level LW,

“buffer usage is at an average level”: the number Q of PDUs pending processing is above the low watermark level LW but below a high watermark level HW,

“buffer is highly used”: the number Q of PDUs pending processing is above the high watermark level HW but below a buffer usage limit L, and

“buffer usage is above buffer capacity” the number Q of PDUs pending processing is above the buffer usage limit L.

In accordance with an implementation in which each output port has only one associated output buffer 112, the output buffer state entry 122 may encode a port utilization state in a third bit:

“port transmit rate below capacity” when a current port transmit rate R is below the maximum allocated transmit rate, and

“port is oversubscribed” when the current port transmit rate R is above the maximum allocated transmit rate.

It is understood that the structure of the output buffer state database 120 and the structure of the output buffer state entries 122 presented above is exemplary only; other implementations may be used without departing from the spirit of the invention.

FIG. 3 is a schematic diagram showing an input buffer state database portion of the data traffic management database in accordance with an exemplary embodiment of the invention.

The input buffer state database may be implemented via look-up table 130 having input buffer state entries 132. An exemplary input buffer state entry 132 is shown to store a current bit encoded state of the associated input buffer 106.

In accordance with the example shown, two bits may be used to encode a current input buffer occupancy state from a selection of states corresponding to conditions such as:

“buffer is lightly used”: a number Q of PDUs pending processing is lower than a low watermark level LW,

“buffer usage is at an average level”: the number Q of PDUs pending processing is above the low watermark level LW but below a high watermark level HW,

“buffer is highly used”: the number Q of PDUs pending processing is above the high watermark level HW but below a buffer usage limit L, and

“buffer usage is above buffer capacity” the number Q of PDUs pending processing is above the buffer usage limit L.

The input buffer state entry 132 may encode a port utilization state in a third bit:

“port receive rate below capacity” when a current port receive rate R is below the maximum allocated receive rate, and

“port is oversubscribed” when the current port receive rate R is above the maximum allocated receive rate.

It is understood that the structure of the input buffer state database 130 and the structure of the input buffer state entries 122 presented above is exemplary only; other implementations may be used without departing from the spirit of the invention.

FIG. 4 is a schematic diagram showing a data session state database portion of the data traffic management database in accordance with an exemplary embodiment of the invention.

The data session state database may be implemented via list 140 having at least one entry per port. Each entry in the list 140 may itself be a list 142 of active sessions for a particular port.

Typically the list of active sessions 142 has a dynamic length adjusted as sessions whose data traffic is conveyed via the associated port are set-up, torn-down, timed-out, etc. More details will be presented below with reference to FIG. 6.

In accordance with the example shown, a bit may be used per session to encode a current session traffic state:

“current session traffic rate below allocated rate”, and

“current session traffic rate above allocated rate”.

It is understood that the structure of the data session state database 140 and the structure of each list of active sessions per port 142 presented above is exemplary only; other implementations may be used without departing from the spirit of the invention.

FIG. 5 is a schematic diagram showing a data traffic shaping rule database portion of the data traffic management database in accordance with an exemplary embodiment of the invention.

The data traffic shaping rules database may be implemented via look-up table 150 having traffic shaping rule entries 152. An example traffic shaping rule entry 152 is shown to store bit encoded conditions and corresponding bit encoded actions to be taken if the conditions are fulfilled.

In accordance with the example shown, two bits may be used to encode a buffer occupancy condition from a selection of conditions corresponding to conditions such as:

“buffer is lightly used”: a number Q of PDUs pending processing is lower than a low watermark level LW,

“buffer usage is at an average level”: the number Q of PDUs pending processing is above the low watermark level LW but below a high watermark level HW,

“buffer is highly used”: the number Q of PDUs pending processing is above the high watermark level HW but below a buffer usage limit L, and

“buffer usage is above buffer capacity” the number Q of PDUs pending processing is above the buffer usage limit L.

A third bit of the traffic shaping rule entry 152 may encode a data flow condition:

“flow rate below allocated rate”, and

“flow rate above allocated rate”.

A fourth bit of the traffic shaping rule entry 152 may encode a primary action to be taken if the conditions are fulfilled:

“discard PDU”, or

“forward PDU”.

A fifth bit of the traffic shaping rule entry 152 may encode an optional secondary action to be taken if the conditions are fulfilled:

“send flow control pause upstream”, or

“suppress sending flow control pause upstream”.

A sixth bit of the traffic shaping rule entry 152 may encode whether a PDU processing update notification is sent to the traffic management processor 104:

“send PDU processing update notification”, or

“suppress sending PDU processing update notification”.

Further details regarding PDU processing update notifications is presented below with reference to FIG. 6.

The following is an exemplary portion of the data traffic shaping rule database:

Unicast

| | | | | Send |
|---|---|---|---|---|
| Buffer State | Rate state | Action | 2nd action | notification |
| L < Q | Allocated < R | Drop PDU | send pause | No |
| | R < Allocated | Drop PDU | send pause | Yes |
| HW < Q < L | Allocated < R | Send PDU | send pause | Yes |
| | R < Allocated | Send PDU | send pause | Yes |
| LW < Q < HW | Allocated < R | Send PDU | send pause | Yes |
| | R < Allocated | Send PDU | | Yes |
| Q < LW | Allocated < R | Send PDU | | Yes |
| | R < Allocated | Send PDU | | Yes |

It is understood that the structure of traffic shaping rule database 150 and the structure of the traffic shaping rule entries 152 presented above is exemplary only; other implementations may be used without departing from the spirit of the invention.

FIG. 6 is a flow diagram showing process steps performing data traffic forwarding and management in accordance with an embodiment of the invention.

The process starts with receiving a PDU from one of the interfaces 106, in step 200. The switching processor 102, typically operating in an event driven mode, is triggered to process the received PDU in step 202 and in step 204, extracts from the received PDU routing information held therein. In step 206, the received PDU is stored in one of the input buffers 108 awaiting processing.

The switching processor 102 queries the DTM DB 114 in step 208 determining data traffic flow enforcement constraints imposed on the input port. Based on the data traffic flow enforcement constraints imposed on the input port via the above mentioned data traffic shaping rules 152, the switching processor 102 takes an action in step 210.

If the PDU is to be discarded, in step 210, the PDU is removed from the input buffer 108 in which it was stored, in step 212 and a PDU processing update notification 216 may be provided to the traffic management processor 104 in accordance with the specification in the applied data traffic shaping rule 152.

If the PDU is to be forwarded, step 210, the switching processor 102 queries the SW DB 110 in step 216 to determine an output port and an associated output buffer 112.

The switching processor 102 queries the DTM DB 114 in step 218 determining data traffic flow enforcement constraints imposed on the output port. Based on the data traffic flow enforcement constraints imposed on the output port via the above mentioned data traffic shaping rules 152, the switching processor 102 takes an action in step 220.

If the PDU is to be discarded in step 220, the PDU is removed from the input buffer 108 in which it was stored, in step 222 and a PDU processing update notification 224 may be provided to the traffic management processor 104 in accordance with the specification in the applied data traffic shaping rule 152.

If the PDU is to be forwarded in step 220, the PDU is switched, in step 226, from the input buffer 108 in which it is stored to the output buffer 112 determined in step 216. Subsequently, the PDU is scheduled for transmission 228 and sent to an appropriate interface 106 in step 230. A PDU processing update notification 234 may be provided to the traffic management processor 104 in accordance with the specification in the applied data traffic shaping rule 152.

The provision of the PDU processing updates 214, 224, 234, activates a trigger in step 236. The trigger is associated with the traffic management processor 104.

The traffic management processor 104, on the activation of the trigger, obtains the PDU processing update (238) and extracts the information held therein. Subsequent to extracting the PDU processing information, the traffic management processor 104 queries the DTM DB 114 in step 240 and the SLA DB in step 242. The traffic management processor 104 computes flow enforcement parameters in step 244 and updates the DTM DB 114 in step 246.

An aspect of the invention is the event driven mode of operation of the switching (102) and traffic management (104) processors. The switching processor 102 is activated when a PDU is received (or pending transmission in a buffer). The traffic management processor 104 is activated via the trigger when the switching processor 102 provides a PDU processing update. The invention is not limited to this implementation. In accordance with another implementation the trigger activation may include the generation of an interrupt. According to yet another implementation no trigger activation is used—the traffic management processor 104 operating in a polling loop periodically inspecting a buffer such as the working store 118.

Another important aspect of the invention is that the switching processor 102 is relieved from performing intensive calculations which are offloaded to the traffic management processor 104. Enforcement of data traffic flow constraints in ensuring guaranteed levels of service is achieved through the application of data traffic shaping rules 152 on processing PDUs.

SLA information is typically input via a console by a system administrator and may be extracted by in-band (session) control messages interpreted by an application at a higher protocol layer, but the invention is not limited thereto.

Another important aspect of the invention is the information exchange between the switching processor 102 and the traffic management processor 104. The invention is not limited to a particular type or mode of inter-processor information exchange; asynchronous modes of information exchange are preferred and characterized in adding only a minimal processing overhead to the operation of the switching processor 102 and the traffic management processor 104 in effecting flow control.

To take advantage of parallel processing, information exchange mechanisms are provided between the switching processor 102 and the traffic management processor 104.

A first type of information exchange is a PDU processing request from the switching processor 102 to the traffic management processor 104 and includes the issuing of at least one of the above mentioned PDU update notifications (214, 224, 234).

Typical PDU processing information used for rate computations includes: type of PDU, length of PDU, PDU source and PDU destination.

In accordance with the exemplary embodiment presented above with reference to FIG. 6, the PDU processing notifications (214, 224, 234) are buffered in the working store 118 later to be retrieved (238) by the traffic management processor 104 during a polling cycle.

The issuing of PDU processing notifications may alternatively be communicated to the traffic management processor 104 by other methods including messaging, direct memory writes, etc.

A second optional type of information exchange includes an update request signal from the traffic management processor 104 to the switching processor 102.

In accordance with another implementation of the invention, a portion of the DTM DB 114 is kept in registers associated internally with the switching processor 102. The traffic management processor 104 can have access to switching processor 102 memory directly without interrupting the operation of the switching processor 102. Therefore update requests are needed to enable the switching processor 102 to update its registers. Such an update request is shown in FIG. 6 at 248. Other traffic management information is updated periodically as part of an execution loop of the switching processor 102.

Implementations taking advantage of hardware acceleration features such as burst writes, multi-ported random access memory storage for concurrent access thereto by the switching processor 102 and the traffic management processor 104, etc. are preferred but optional—the design choice being largely governed by a cost-performance tradeoff.

Although the methods described herein provide data traffic processing with limited resources additional enhancements can be achieved when the processors and the data traffic management database may use a dedicated data bus or multiple data buses.

Since the data switching node operates below the session layer, session control messages which explicitly set-up and tear-down sessions are not processed as such. A record for a new data session is created in the DTM DB 114 when a PDU is received with a new “condition” that has not been seen before. The condition can be a different value in VLAN ID, different source MAC ADDR, etc. Typically what can be used is a field value held in PDU headers that was not previously received or updated for a long period of time.

A data session can be torn-down when there is no activity associated with the data session for certain period of time. This requires the traffic management processor 104 to periodically scan a list of active data sessions to find out data sessions that have expired. Each data session may be labeled with a timestamp updated with the processing of each associated PDU. The timestamp may be implemented in the DTM DB 114, the SLA DB 116 or Working Store 118.

The features presented above may be implemented in any data network node performing differentiation of data traffic flows. The data traffic flow may be differentiated on a per subscriber basis, or based on a types of traffic associated with but not limited to: a type of service (TOS) specification in a PDU header, a VLAN priority specification, a Transport Control Protocol/User Datagram Protocol (TCP/UDP) port number, Differentiated Services specification, Quality of Service specification (QoS), etc. or combinations thereof.

Two switching processors are used to satisfy computation power needed for dynamic traffic shaping, and buffer control. The traffic management processor 104 is used for real time computation of data session rates, comparing traffic with predefined SLA specifications, and providing the results to the switching processor 102. The invention is not limited to implementations of the above presented methods using a single switching processor 102 and a single traffic management processor 104, the methods presented apply equally well to data switching equipment having a plurality of switching processor 102 and a plurality of traffic management processors.

The embodiments presented are exemplary only and persons skilled in the art would appreciate that variations to the above-described embodiments may be made without departing from the spirit of the invention. The scope of the invention is solely defined by the appended claims.

We claim:

1. A data switching node having a switching engine comprising:
a. a data traffic management database,
b. a data traffic management processor updating the data traffic management database in performing data traffic management, and
c. a data switching processor switching data traffic based on routing entries in a switching database subject to data traffic shaping criteria held in the traffic management database
whereby the data traffic management processor relieves the data switching processor of intensive traffic management computations in providing guaranteed levels of service.

2. A data switching node as claimed in claim 1, wherein the data traffic management database stores resource utilization information, the resource utilization information specifying a current state of the data traffic conveyed by the data switching node.

3. A data switching node as claimed in claim 2, wherein the resource utilization information is stored in a bit encoded form.

4. A data switching node as claimed in claim 1, wherein the data traffic shaping criteria includes data traffic shaping heuristics enabling the data switching processor to enforce service level guarantee data traffic constraints on data traffic flows processed by the data switching node.

5. A data switching node as claimed in claim 1, wherein the switching engine further comprises a service level agreement database associated with the data traffic management processor, the service level agreement database holding service level guarantee specifications in providing data services.

6. A data switching node as claimed in claim 1, wherein the data switching node further comprises information exchange means enabling communication between the data switching processor and the data traffic management processor.

7. A data switching node as claimed in claim 6, wherein the information exchange means includes a communications protocol providing notification to the data traffic management processor upon processing at least one Payload Data Unit (PDU).

8. A data switching node as claimed in claim 7, wherein the communications protocol further provides notification to the data switching processor upon updating the data traffic management database.

9. A data switching node as claimed in claim 6, wherein the information exchange means includes a working store.

10. A data switching node as claimed in claim 9, wherein the working store comprises multi-ported random access memory enabling concurrent access thereto by the data switching processor and the data traffic management processor.

11. A data switching node as claimed in claim 9, wherein the data traffic management processor includes the working store.

12. A data switching node as claimed in claim 9, wherein the information exchange means includes a communication protocol, the communications protocol including direct memory writes to the working store in providing notification of the processing of the at least one PDU.

13. A data switching node as claimed in claim 6, wherein the information exchange means includes data registers internally associated with the data switching processor, the data registers storing at least a portion of the data traffic management database.

14. A data switching node as claimed in claim 13, wherein the data registers comprise multi-ported random access memory enabling concurrent access thereto by the data switching processor and the data traffic management processor.

15. A data switching node as claimed in claim 13, wherein the information exchange means includes a communications protocol, the communications protocol including direct memory writes to the data registers on updating the data traffic management database.

16. A data switching node as claimed in claim 7, wherein the information exchange means further comprises a trigger associated with the data traffic management processor, the trigger being activated by a notification of processing of the at least one PDU.

17. A data switching node as claimed in claim 6, wherein the information exchange means further comprises at least one dedicated data bus for communication between the data switching processor and the data traffic management processor.

18. A method of enforcing service level agreements for data traffic flows conveyed by a multiport data switching node, the method comprising steps of:
a. extracting header information from a Payload Data Unit (PDU) received by a switching processor from an input port of the data switching node;
b. querying a switching database to determine an output port to forward the PDU;
c. querying a data traffic management database maintained by a data traffic management processor, the data traffic management database storing data traffic management information;
d. processing the PDU subject to data traffic constraints and current states of the data traffic flows included in the data traffic management information;
e. selectively providing feedback information to the data traffic management processor regarding actions taken by the switching processor in processing the PDU; and
f. updating the data traffic management database upon computing a current state of the data traffic flows based on the provided feedback information
whereby the switching processor is relived of intensive data traffic management computations.

19. A method as claimed in claim 18, wherein processing the PDU the method further comprises a step of processing the PDU subject to data traffic shaping heuristics providing data traffic flow control for the input port.

20. A method as claimed in claim 18, wherein processing the PDU the method further comprises a step of processing the PDU subject to data traffic shaping heuristics providing data traffic flow control for the output port.

21. A method as claimed in claim 18, wherein computing the current state of the data traffic flows the method further comprises the step of querying a service level agreement database associated with the traffic management processor to determine service level guarantees.

22. A method as claimed in claim 18, wherein processing the PDU the method further comprises a step of processing the PDU subject to data traffic shaping heuristics providing data traffic flow control for the output port.
